(19) United States
(12) Patent Application Publication
(10) Pub. No.: US 2007/0055605 A1
(43) Pub. Date: Mar. 8, 2007

(54) Pension plan designs and methods for eliminating potentially age discriminatory accruals from cash balance pension plans

(76) Inventors: John H. Moore, Englewood, CO (US); John H. Lowell, Woodstock, GA (US); Brian C. Donohue, Schaumburg, IL (US); Jeffrey W. Stevenson, Prospect Heights, IL (US); Kenneth A. Balinski, Arlington Hts., IL (US); Timothy P. Mahannah, Oakland, CA (US)

Correspondence Address: DINSMORE & SHOHL, LLP, 1900 CHEMED CENTER, 255 EAST FIFTH STREET, CINCINNATI, OH, 45202, US

(21) Appl. No.: 11/511,904

(22) Filed: Aug. 28, 2006

Related U.S. Application Data
(60) Provisional application No. 60/711,909, filed on Aug. 26, 2005.

(51) Int. Cl. G06Q 40/00

(52) U.S. Cl. 705/36 T

(57) ABSTRACT

Defined benefit pension plans wherein an accrued benefit is capable of satisfying accrual rules of Internal Revenue Code Section 411(b)(1) using the 133 ⅓% rule of subparagraph B, that incorporate particular pension plan design components, and methods for reducing exposure to civil liability based on provisions of the Employee Retirement Income Security Act (ERISA) and/or the Internal Revenue Code (IRC) relating to age discrimination that is associated with funding defined benefit pension plans, including cash balance plans, by employing the novel plan designs.

### RELATED APPLICATION

This application claim priority to U.S. Provisional Application No. 60/711909, filed Aug. 26, 2005.

### FIELD OF THE INVENTION

The present invention relates generally to pension plan designs and provides novel plan designs and methods which comport with administrative, statutory and judicial mandates in a cost-effective manner. In particular, the invention provides novel designs and methods for eliminating certain risks associated with implementation of specified pensions plans, including but not limited to cash balance pension plans. The invention further provides methods of smoothing the costs associated with cash balance pension plans by combining certain embodiments of the novel pension design with a variable annuity plan design.

### BACKGROUND OF THE INVENTION

The first cash balance pension plan was implemented in the United States in 1985. Since that time, many more such cash balance pension plans have been put in place. After 20 years, however, several questions have arisen as to the inherent legality of such plans. Most typically, defined benefit pension plans, defined in 26 C.F.R. §414(j), are found to be in compliance with the Employee Retirement Income Security Act (ERISA), and are tax-exempt under §§401 and 501 (and the associated regulations) of the Internal Revenue Code, but no such regulations are in force which address the specific issues of cash balance pension plans.

As a result of certain recent legal challenges, cash balance plans have come under legal scrutiny that has created an unaccounted for and unresolved risk. In particular, district courts in several federal judicial circuits have held that particular cash balance plans are in violation of a subsection of the Employee Retirement Income Security Act (ERISA) that prohibits age discrimination. Two ERISA provisions are implicated in this assertion. ERISA §204(b)(1)(G) provides that a defined benefit plan does not satisfy ERISA's benefit accrual requirements “if the participant's accrued benefit is reduced on account of any increase in his age or service,” and ERISA §204(b)(1)(H)(i) provides that a defined benefit plan does not satisfy these requirements “if, under the plan, an employee's benefit accrual is ceased, or the rate of an employee's benefit accrual is reduced, because of the attainment of any age.” See Cooper et al. v IBM Personal Pension Plan et al. 274 F. Supp. 2d 1010 (S.D. Ill. 2003) (holding that cash balance formulas are inherently age discriminatory because identical interest credits necessarily buy a smaller age 65 annuity for older workers than for younger workers due to the time value of money), and Richards v FleetBoston Financial (holding that the cash balance plan violates section 204(b)(1)(G) because, inter alia, under the formula, employees of different ages that work for the same number of years and earn identical salaries will accrue different retirement benefits) Similar challenges are pending in district court in other circuits.

Adding to the uncertainty, on Aug. 7, 2006, the Seventh Circuit Court of Appeals overturned the Cooper district court, finding cash balance designs to be age-neutral and permitted under ERISA so long as transitions from traditional designs do not diminish vested interests. The Court is currently considering an en banc appeal of this decision. In the event the decision is upheld, and, in particular in the event that Richards is also upheld, or if any of the other cases currently pending in district courts of various circuits resolve differently and are sustained on appeal, the specter arises of a circuit split and near certain Supreme Court certification of the question. Until then, employers sponsoring a cash balance plan, or employers seeking to transition to a cash balance plan, face considerable exposure to liability and a likely threat of litigation.

Currently, plan sponsors may preserve their cash balance plans and face a virtually incalculable exposure to liability, or face an expensive and regulation-burdened transition to an alternative plan design. Clearly, there is an urgent and unmet need in the actuarial pension arts for cash balance plan designs which overcome these problems.

The present invention provides cash balance pension plan designs and methods that resolve the issue the and eliminate the risk associated therewith, without making significant changes to the cost of providing the benefits or the pattern of accrual of benefits according to cash balance plans.

### SUMMARY OF THE INVENTION

Accordingly, the present invention provides novel defined benefit pension plan designs and methods which substantially reduce or eliminate one or more of the risks associated with implementation of cash balance pension plans, and related plans, by employing one or more of seven pension plan design components that have not previously been applied to cash balance plans.

Adaptation and application of the seven pension plan design components disclosed herein, and the methods employing them, afford a unique solution to the problems facing cash balance pension plan sponsors, by, inter alia, reducing exposure to liability.

One embodiment of the invention provides a defined benefit pension plan wherein an accrued benefit is capable of satisfying accrual rules of Internal Revenue Code Section 411(b)(1) using the 133⅓% rule of subparagraph B. The plan incorporates at least four of the following pension plan design components: i. a football-shaped pattern of accrual boundary wherein a participant's normal retirement benefit is at least as great as the greatest of the participant's early retirement benefits, and a single sum distribution from a defined benefit pension plan is not be less than the amount so specified; ii. an Early Retirement Factor (ERF) defined for each participant and wherein the ERF is neither a tabular reduction nor an actuarial equivalent reduction; iii. an ERF defined for each participant using factors comprising date of birth, date of hire, and compensation history with an employer; iv. an accrued benefit defined by the fractional rule according to Internal Revenue Code Section 411(b)(1)(C); v. determination of a participant's benefit using more than 10 years of compensation; vi. expansion of the accrual boundary by use of a Social Security Supplement; and vii. a pre-age 65 Normal Retirement Age in combination with a Social Security Supplement payable until Social Security Normal Retirement Age.

The invention also provides methods for reducing exposure to civil liability based on provisions of the Employee Retirement Income Security Act (ERISA) and/or the Internal Revenue Code (IRC) relating to age discrimination where the exposure is associated with implementation and/or funding of a defined benefit pension plan. The method comprises: designing a defined benefit pension plan, wherein an accrued benefit satisfies accrual rules of IRC Section 411(b)(1) using the 133⅓% rule of subparagraph B, according to at least four out of seven specified design elements.

The inventive methods may be computer implemented wherein a computer system comprises a processor or central processing unit for implementing the logic associated with the methods. The processor may house the logic, or may be in communication with a unit which houses the logic. Participant data may be provided as input to the processor whereby the logic is applied to the input to determine an accrued benefit according to the inventive pension plan.

### BRIEF DESCRIPTION OF THE DRAWINGS

FIG. 1. Growth of unattended risk

FIG. 2. Illustration of managed risk

FIG. 3. Pattern of accrual under the invention

FIG. 4. Illustration of the football-shaped pattern of accrual boundary

FIG. 5. Pattern of accrual boundary in a constant return environment

FIG. 6. Illustration of accruals outside the football-shaped boundary

FIG. 7. Use of ancillary benefits to spread the accrual boundary

### DETAILED DESCRIPTION OF THE INVENTION

The following definitions apply to the respective terms as used herein.
1. ACCRUED BENEFIT is equal to the Protected Cash Balance divided by an immediate Normal Retirement Age (NRA) (or current age, if older) annuity factor.
2. CASH BALANCE ACCOUNT (CB) is a notional account representing the accumulation of Pay Credits and Interest Credits.
3. DEFERRED BENEFIT. To the extent that a participant does not elect receipt of the benefit as of the first day of the month following termination of employment, the CB will continue to receive INTEREST CREDITS as if the participant were still employed until the CB equals the Protected Cash Balance (ProtCB). The DEFERRED BENEFIT will equal the greater of the CB or the present value of the ACCRUED BENEFIT calculated using the assumptions specified in Internal Revenue Code Section 417(e). Alternatively, the DEFERRED BENEFIT is the actuarial equivalent of the DEFERRED BENEFIT payable as a single life annuity (unmarried) or qualified joint survivor annuity (QJSA), (married).
4. EARLY RETIREMENT BENEFIT. As of the first day of the month following termination prior to Normal Retirement Age (NRA), a vested participant may elect early commencement of his benefit in the amount of his EARLY RETIREMENT BENEFIT. The available lump sum will equal the CB, but not greater than the Protected Cash Balance (ProtCB), nor less than the present value of the ACCRUED BENEFIT using the assumptions specified in Internal Revenue Code Section 417(e). The normal form of payment of this benefit is the single life annuity for unmarried participants, or the Qualified Joint Survivor Annuity (QJSA) for married participants.
5. EARLY RETIREMENT FACTOR (ERF) is equal to the EARLY RETIREMENT BENEFIT divided by the ACCRUED BENEFIT.
6. INTEREST CREDITS. At the end of each month (or other crediting period not longer than one year) through termination of employment, the CB as of the beginning of the month receives INTEREST CREDITS based on the 30-year Treasury rate (or some other index allowed in IRS Notice 96-8) as of some period permissible under Notice 96-8.
7. NORMAL RETIREMENT BENEFIT. After termination and upon attainment of NRA, a vested participant is entitled to commence receipt of his accrued benefit, called the NORMAL RETIREMENT BENEFIT, as a single life annuity (if not married) or as an actuarially equivalent qualified joint and survivor (QJSA) (if married). Alternatively, the participant may receive his Protected Cash Balance (ProtCB) as a lump sum.
8. PAY CREDITS. A specified percentage of compensation credited to the CB at the end of each month (or other crediting period not longer than one year) of employment.
9. PROJECTED CASH BALANCE (Proj CB) The CB projected to normal retirement age (NRA) assuming continued employment to NRA, future PAY CREDITS based on PROJECTED COMPENSATION, and future INTEREST CREDITS based on the interest rate in effect at the time of determination, which may be any point until the end of the month (or other crediting period not longer than one year) of termination of employment. The ProjCB is frozen as of the end of the month (or other crediting period not longer than one year) of termination of employment.
10. PROJECTED COMPENSATION. The average monthly (or some other period not greater than one year) compensation recognized under the plan for the period beginning with employment and ending with termination, but in no case including more than the last 120 months of employment.
11. PROTECTED CASH BALANCE (ProtCB). The ProjCB times a fraction (not greater than 1) the numerator of which is the credited service under the plan and the denominator of which is the projected service under the plan at NRA assuming continued employment. The ProtCB cannot be less than the ProtCB as of the end of any prior plan year. Otherwise, it is defined as equal to the greatest of any ProtCB as of the end of any prior plan year.

12. SMOOTHING refers to any of costs, assets, or liabilities. When SMOOTHING refers to costs, it means that costs taken over a long period of time are moved toward an average. In other words, costs that are above average are decreased and costs below that average are increased using standard mathematical and actuarial techniques. When smoothing refers to assets or liabilities of a plan, it means that deviations from actuarially expected results are recognized over a specified period of time, usually three or five years.

Under the current litigious climate buttressed by the successful legal challenge of the Cooper plaintiff class, employers providing and funding typical cash balance designs face significant exposure to liability and risk of litigation. The present inventors have discovered a novel plan design that overlays the cash balance plan, permitting employers to maintain their cash balance plans while substantially diminishing the litigation risk associated with funding cash balance and related plans.

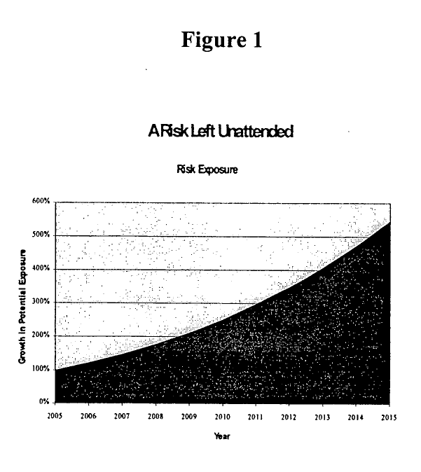

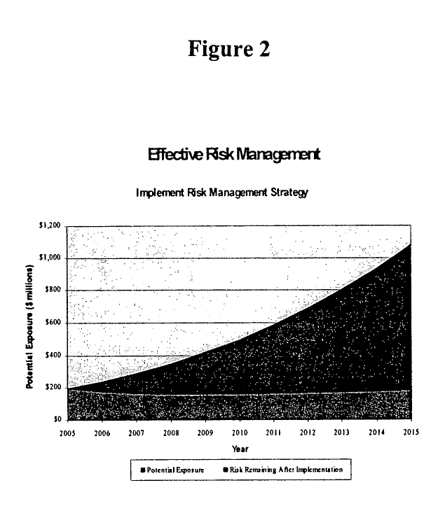

For example, assume that a company employs a typical cash balance plan. Then, under recent case law analysis, the pattern of growth of said litigation risk would look approximately as depicted in FIG. 1. For that same company, the expected effect on litigation risk by adopting one embodiment of the present inventive design would more closely approximate the graphical representation set forth in FIG. 2. The red area represents the diminished litigation risk, while the gray area represents remaining risk.

For purposes of the present invention, a defined benefit plan is defined in accordance with 26 C.F.R. §414(j), and applicable defined benefit plans, including cash balance plans are considered a subset thereof Defined lump sum pension plans, also known in the art as a Pension Equity Plan, have characteristics that may subject them to the same legal analysis as cash balance plans, and the presently inventive plans and methods are similarly applicable to this type of plan as well.

Existing cash balance pension plan designs follow either a flat percentage (e.g., 5% of pay) allocation rate or some graded schedule of allocation rates (e.g., 4% of pay for the first 10 years, 5% of pay for the next 10 years, and 6% of pay thereafter) where these “pay credits” grow with interest at some notional rate of return, usually linked to United States Treasury debt issues. These plans most commonly provide benefits to plan participants in the form of a single sum payment (Equal to the cash balance, unless “whipsaw” comes into play, whereby the amount of benefit that must be paid to a participant under a single sum distribution election is larger than the participant's account balance. This generally occurs when the discount rate specified by a cash balance plan for actuarial equivalence is greater than the discount rate specified by 26 C.F.R. 1.417(e)-1(d)(3)), or alternatively as an actuarially equivalent life annuity. These plans do not provide for early retirement subsidies. The benefits under these plans accrue using the “133⅓% rule” found in ERISA §204(b)(1)(B).

In the context of defined benefit pension plans, a participant's pattern of accrual relates to the general pattern of growth in the amount to which that participant is entitled. For example, the amount could grow by a flat dollar amount each year, or by a percentage of yearly compensation, or by any other scheme.

Two forms of benefit are said to be actuarially equivalent to one another when, given specific actuarial assumptions regarding interest (rates of return on investments) and mortality (rates of death), the expected present value of the benefits to be paid under one form is equal to the expected present value of the benefits to be paid under the other form. For example, if one form of benefit is a lump sum (single immediate cash payment), an actuarially equivalent life annuity is a constant stream of monthly (or other time period not greater than one year) payments to the participant for the remainder of his or her lifetime with an expected present value equal to the amount of the lump sum payment.

The inventors discovered that application of some permutation of seven retirement system concepts, heretofore not considered applicable and therefore not previously applied in cash balance plan design, provides a unique cash balance plan design.

One embodiment of the present invention is directed to a defined benefit pension plan wherein an accrued benefit is capable of satisfying accrual rules of Internal Revenue Code Section 411(b)(1) using the 133⅓% rule of subparagraph B. An accrual, or the benefit associated with that accrual is said to be backloaded if too great a proportion of that benefit accrues during a participant's later years of service. If the benefit is backloaded, then the defined benefit plan of which it is a part will not be a qualified (tax-favored) plan. Proof that backloading does not exist may be through any of three rules as follows: 26 CFR 411(b)(1)(A); 26 CFR 411(b)(1)(B); and 26 CFR 411(b)(1)(C).

The present inventors are unaware of any other way to prove that a defined benefit plan is not backloaded. The benefit according to the present invention satisfies the accrual rules using the fractional rule, however, the benefit also is capable of satisfying the 133⅓ rule. While a benefit need only satisfy one of these rules to prove that backloading does not exist, some embodiments of the present invention desirably and beneficially use the fractional rule.

According to one embodiment, the inventive defined benefit pension plan incorporates at least four of the following pension plan design components:

(i). A football-shaped pattern of accrual boundary wherein a participant's normal retirement benefit is at least as great as the greatest of the participant's early retirement benefits, and a single sum distribution from a defined benefit pension plan is not be less than the amount so specified. The upper bound of the football is the benefit defined in Internal Revenue Code (IRC) Section 411(a)(9). That is, a participant's normal retirement benefit must be at least as great as the greatest of his early retirement benefits. The lower bound of the football is defined by IRC 417(e)(3) which specifies that a single sum distribution from a defined benefit pension plan may not be less than the amount so specified. When this amount exceeds a cash balance participant's notional account balance, whipsaw is said to occur.

(ii). An Early Retirement Factor (ERF) defined for each participant and wherein the ERF is neither a tabular reduction nor an actuarial equivalent reduction. According to the existing art in defined benefit pension plans, ERFs are defined in either tabular form, or by strict adherence to actuarial equivalence. The present inventive design and method, on the other hand, uses ERFs formulaically determined for each participant in such a way that they are neither tabular, nor actuarial equivalent reductions.

(iii). An ERF defined for each participant using factors comprising date of birth, date of hire, and compensation history with an employer. The ERFs vary by participant so that only rarely will these factors be identical between any two participants such that they would have the same ERF.

(iv). An accrued benefit defined by the fractional rule according to Internal Revenue Code Section 411(b)(1)(C). While the accrued benefit derived according to the invention satisfies the accrual rules of IRC Section 411(b)(1) using the 133⅓% rule of subparagraph (B), the benefit accrues by using the “fractional rule” of IRC Section 411(b)(1)(C), and, therefore, alternatively satisfies those same accrual rules using the fractional rule. The current state of the art in cash balance pension plan design shows does not employ the fractional rule to define the accrued benefit.

(v). Determination of a participant's benefit using more than 10 years of compensation. It is considered common knowledge to a person of ordinary skill in the pension practice arts that the fractional rule can not be used in any pension plan design wherein more than 10 years of compensation is used in the determination of the participant's benefit. By using Example 2 (which relies on the facts of Example 1) of 26 CFR 1.411 (b)-1(b)(3)(iii)(2), the present inventors have developed a unique method that operates within the methodological rules specified by the Internal Revenue Service and establishes a permissible use of the fractional rule for a plan that uses more than 10 years of compensation in determining the participant's benefit.

Examples 1 and 2, as referenced above, are set forth in their entirety below:

### EXAMPLE 1

“The M Corporation's defined benefit benefit plan provides an annual retirement benefit commencing at age 65 or $4 per month for each year of participation. As a condition of participation, the plan requires that an employee have attained age 25. The normal retirement age specified under the plan is age 65. The plan provides for no limit on the number of years of credited service. A, age 40, is a participant in the M Corporation's plan. A has completed 12 years of participation in the plan of the M Corporation as of the close of the plan year. Under subdivision (i) of this subparagraph, the normal retirement benefit commencing at age 65 to which a participant would be entitled if he commenced participation at the earliest possible entry age (25) under the plan and served continuously until normal retirement age (65) is an annual benefit of $1,920 [40×(12×$4)]. Under paragraph (b)(1)(i) of this section, the plan does not satisfy the requirements of this subparagraph unless A has accrued an annual benefit of at least $691 [0.03×($1,920×12)] as of the close of the plan year. Under the M Corporation plan, A is entitled to an accrued benefit of $576 [(12×12)×$4] as of the close of the plan year. Thus, with respect to A, the accrued benefit provided under the M Corporation plan does not satisfy the requirements of this subparagraph.”

### EXAMPLE 2

“Assume the same facts as in example (1) except that the M Corporation's plan provides that only the first 30 years of participation are taken into account. Under subdivision (i) of this subparagraph, the normal retirement benefit commencing at age 65 to which a participant would be entitled if he commenced participation at the earliest possible entry age under the plan (25) and served continuously until normal retirement age (65) is an annual benefit of $1.440 [30×$48]. Under paragraph (b)(1)(i) of this section, the plan does not satisfy the requirements of this subparagraph unless A has accrued an annual benefit of at least $518 [0.03×($1,440×12)] as of the close of the plan year. Under the M Corporation plan, A is entitled to an accrued benefit of $576 [(12×$48]. Thus, with respect to A, the accrued benefit provided under the M Corporation plan satisfies the requirements of this subparagraph.”

(vi). Expansion of the accrual boundary by use of a Social Security Supplement.

It is also common knowledge among those of ordinary skill in pension plan design that a Social Security Supplement as defined in 26 CFR 1.411(a)-7(c)(4)(ii) is an ancillary benefit. Ancillary benefits are defined benefit plan benefits not directly related to retirement benefits including payment of medical expenses (or insurance premiums for such expenses), disability benefits not in excess of the qualified disability benefit (26 C.F.R. §411(a)(9) and paragraph (c)(3)), life insurance benefits payable as a lump sum, incidental death benefits, current life insurance protection, or medical benefits described in §401(h). As such, it is not subject to the restrictions of 26 C.F.R 1.417(e). Therefore, it does not cause the bottom of the football shape to increase. However, since it may be distributed under 26 CFR 1.417(e), it has the effect of causing the top of the football shape to increase. Said differently, the volume of the football shape increases due to the addition of a Social Security Supplement to the design. In the existing art, Social Security Supplements have been used only for the purpose of providing a temporary benefit. The present inventive design and method uses it to provide increased latitude with respect to the amount of single sum distribution which may be paid.

(vii). A pre-age 65 Normal Retirement Age in combination with a Social Security Supplement payable until Social Security Normal Retirement Age. As is clear from the figures, the football shape pattern tends to narrow, or pinch, as the participant in the inventive design approaches Normal Retirement Age, as defined in 26 CFR 1.411(a)-7(b)(1). Under currently accepted practice, pre-age 65 Normal Retirement Ages are used primarily as a means of encouraging employee retirement at specific ages. According to the presently inventive design and methods, use of a Normal Retirement Age earlier than age 65, in combination with a Social Security Supplement payable until Social Security Normal Retirement Age, as described in 26 CFR 1.411(a)-7(c)(4)(ii)(A), has the effect of mitigating that pinching.

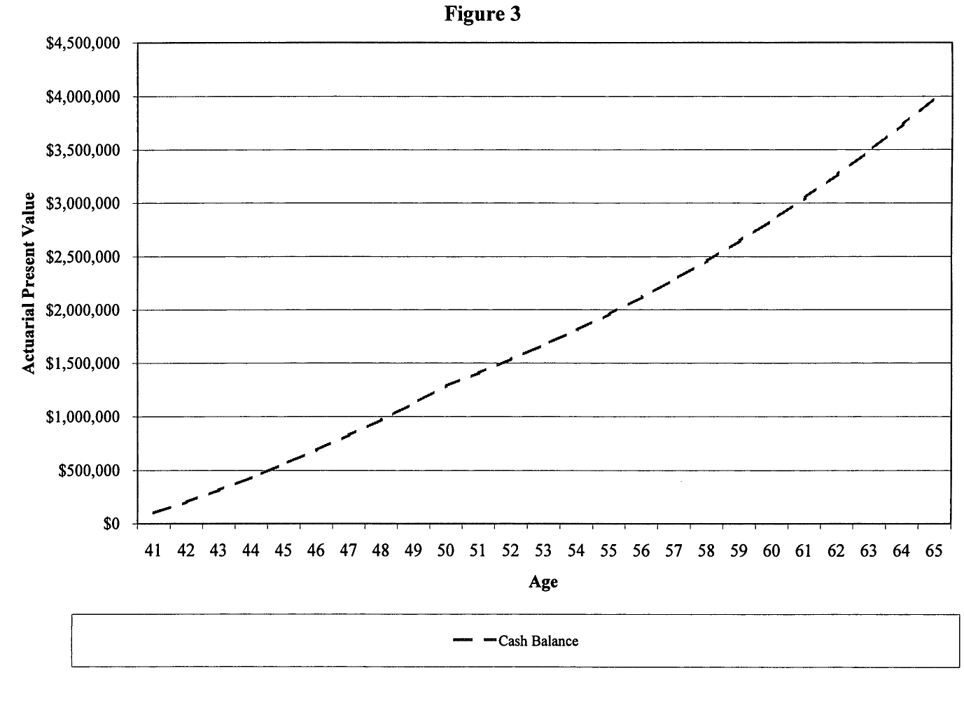

Practice of the inventive design and method in a typical cash balance design yields a participant's pattern of accrual, an example of which is illustrated by FIG. 3, wherein the line labeled “cash balance” shows an accrual pattern according to the invention.

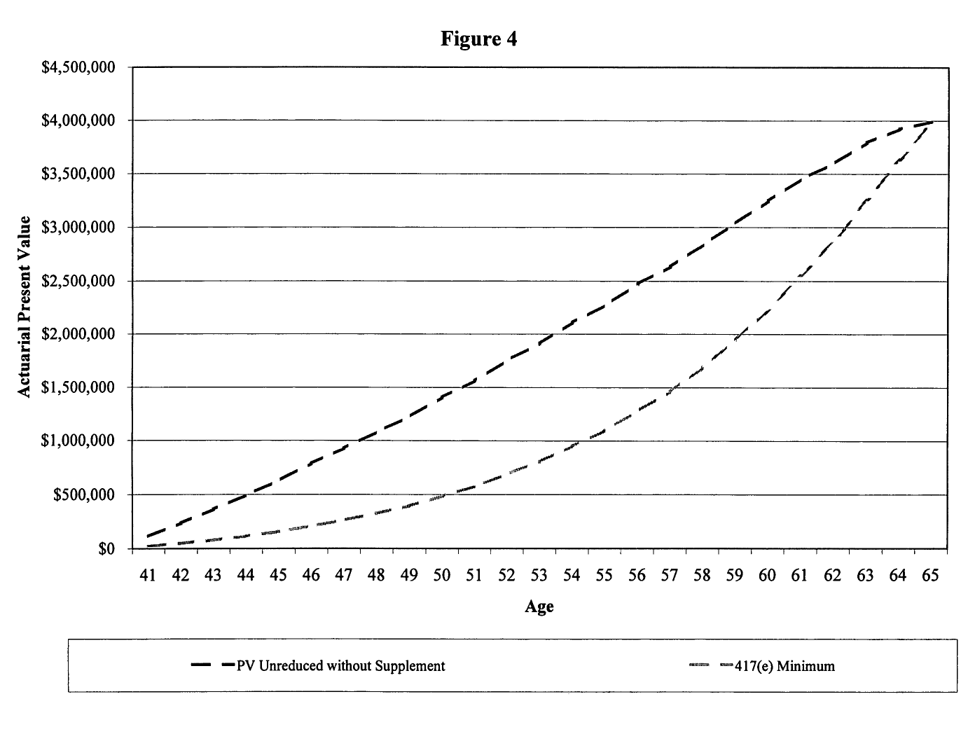

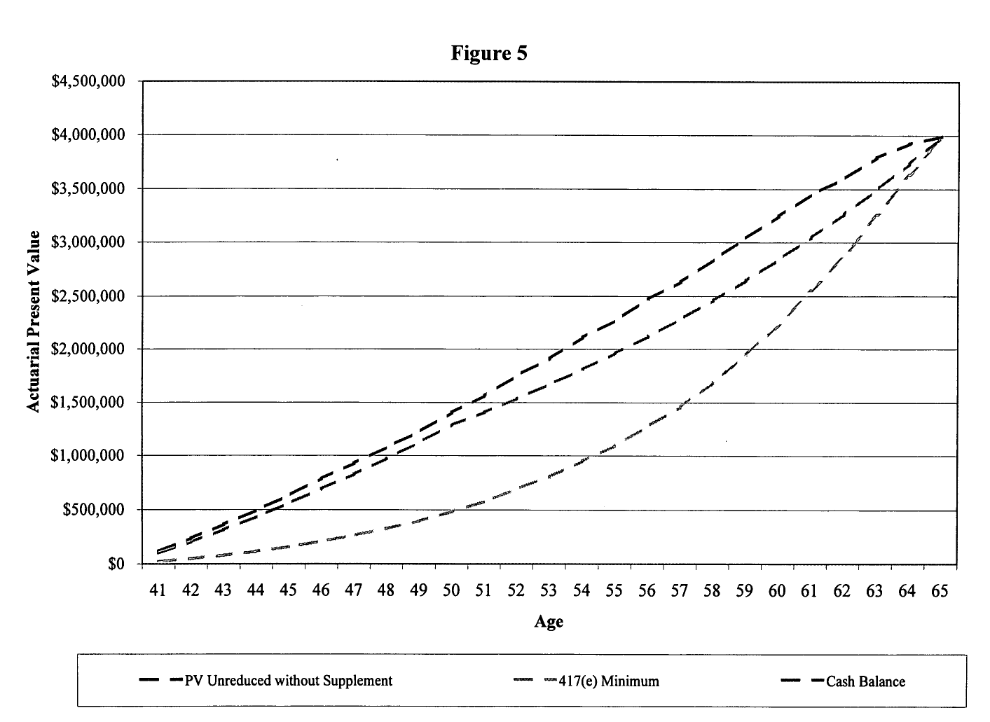

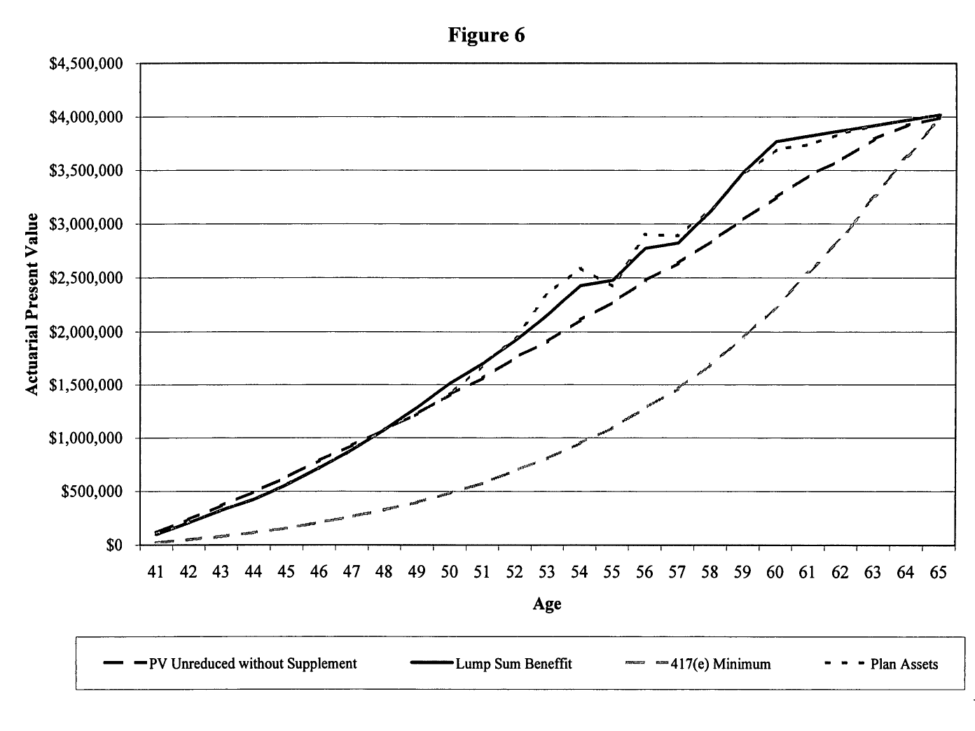

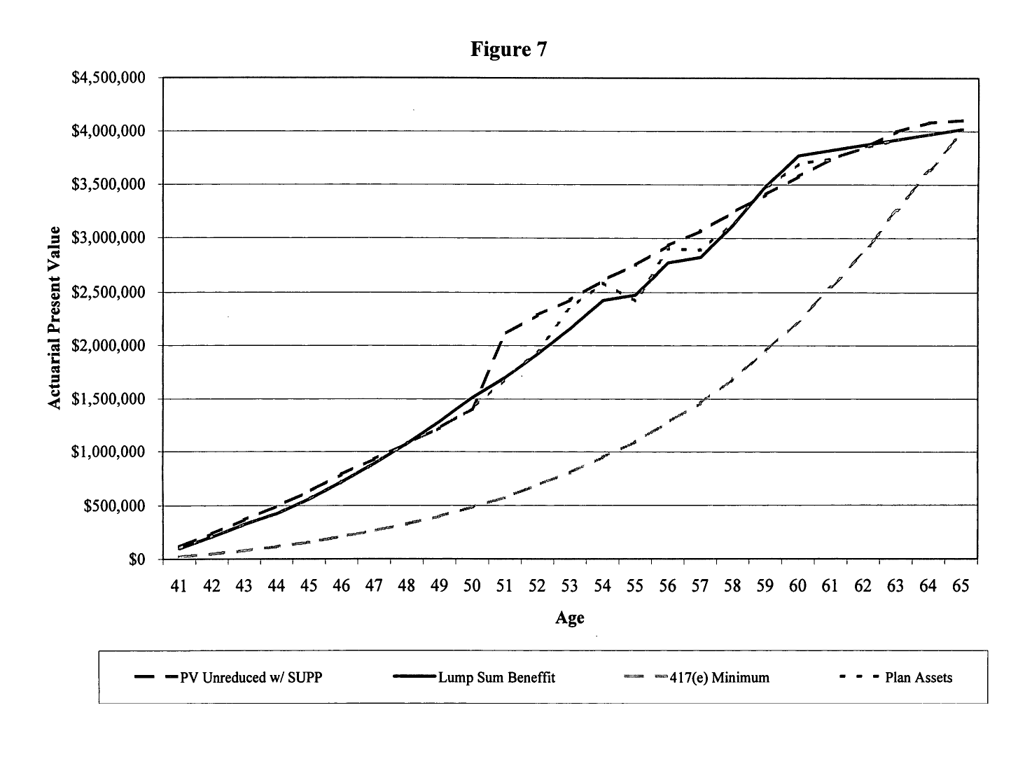

FIGS. 4 through 7 illustrate the advantages of using the sixth and seventh design components. FIG. 4 illustrates the football shape without any accruals. FIG. 5 lays the accruals in the football illustrating a traditional cash balance design overlaid with the inventive methods. FIG. 6 illustrates that the use of variable rates of return in the Measurement Fund, cause the annuity value of the Measurement Fund to fall outside the football-shaped boundaries. FIG. 7 shows that the use of the sixth and seventh component design paradigms significantly increases the likelihood that the Measurement Fund stays within the football-shaped boundaries. This is important because the participant will expect to receive an amount equal to the Measurement Fund, but by law, may only receive an amount within the football-shaped boundaries.

One embodiment provides a method for using the inventive design as an overlay to an existing cash balance formula, so that future accruals comply with the holding in Cooper, while at the same time, the risk attendant to past accruals is rapidly diminished.

Another embodiment of the invention is directed to the inventive defined benefit pension plan comprising an applicable defined benefit plan, wherein the applicable defined benefit plan is defined according to Section 701 of the Pension Protection Act of 2006. According to a more specific embodiment, the defined benefit pension plan comprises either a Cash Balance plan or a Defined Lump Sum plan.

The inventive plan may be designed having as few as four of the pension plan design components incorporated therein. In more specific embodiments, the inventive plan may incorporate 5, 6 or 7 of the plan design components. In a specific embodiment, the defined benefit pension plan comprises design components iv and v, which exhibit interplay to achieve a desired effect.

Another embodiment of the invention provides a method for reducing exposure to civil liability based on provisions of the Employee Retirement Income Security Act (ERISA) and/or the Internal Revenue Code (IRC) relating to age discrimination, such exposure being associated with implementation and/or funding of a defined benefit pension plan. The method comprises: designing a defined benefit pension plan, wherein an accrued benefit is able to satisfy accrual rules of IRC Section 411(b)(1) using the 133⅓% rule of subparagraph B, and the plan is designed according to at least four of the seven design elements set forth in detail above. In a specific embodiment of the method, the defined benefit pension plan is a Cash Balance Plan or a Defined Lump Sum Plan. In very specific embodiments of the method, the defined benefit pension plan is designed according to at least 5, 6 or 7 of the design elements. According to one specific embodiment, the pension plan incorporates design elements iv and v.

According to a further embodiment, a method of providing increased flexibility with respect to an amount of a single sum distribution which may be paid according to a defined benefit pension plan is provided. The method comprises designing the inventive pension plan to incorporate design element vi.

The invention has additional utility in the pension arts, aside from avoiding legal challenges based on age discrimination. By implementing the present pension plan design, the invention further provides a method for stabilizing year to year costs (smoothing) associated with funding certain defined benefit pension plans, including cash balance plans. Smoothing is enhanced by combining the defined benefit pension plan with a variable annuity plan.

The present inventors contemplate that the inventive methods may be computer implemented wherein a computer system comprises a processor or central processing unit for implementing the logic associated with the methods. The processor may house the logic, or may be in communication with a second unit which houses the logic. Participant data may be provided as input to the processor whereby the logic is applied to the input to determine an accrued benefit according to the inventive pension plan.

Another type of hybrid plan, referred to in the art as a Pension Equity Plan (PEP) or Defined Lump Sum plan (DLS), has not been challenged under the doctrine of Cooper, although DLS plans do have many of the same characteristics as cash balance plans. Hence, another embodiment of the inventive method provides adapting and overlaying the inventive plan design onto an existing DLS design to provide the same positive impact as for cash balance, thereby mitigating any potential risk under a case potentially analogous to Cooper. Adaptations necessary to overlay onto the DLS plan would be apparent to one of ordinary skill in the art.

In another embodiment, the inventive design components are employed in a new DLS design to ensure that the plan satisfied all the age discrimination provisions inherent in both the Age Discrimination in Employment Act (ADEA) and in ERISA.

In a further embodiment, the inventive design component paradigms are applied to an existing cash balance structure within a variable annuity plan. In this case, the pre-retirement return on the Cash Balance Account varies based on a specific set of investments, where that return may or may not be constrained by some fixed minimum and maximum return. After retirement, the amount of annuity paid to the participant varies, based on the annual returns of the same type of investments. The novel design is legal under a Cooper analysis, and provides significant cost stability compared to the traditional cash balance design.

While particular embodiments of the present inventive design components, designs, and methods have been discussed with specificity, it will be obvious to one of ordinary skill in the art that the invention may be practiced similarly with respect to analogous pension design situations and the scope of the invention should not be construed as being limited to the specific embodiments illustrated herein.

What is claimed:

1. A defined benefit pension plan, wherein an accrued benefit is capable of satisfying accrual rules of Internal Revenue Code Section 411(b)(1) using the 133⅓% rule of subparagraph B, incorporating at least four of the following pension plan design components:
i. A football-shaped pattern of accrual boundary wherein a participant's normal retirement benefit is at least as great as the greatest of the participant's early retirement benefits, and a single sum distribution from a defined benefit pension plan is not be less than the amount so specified;
ii. An Early Retirement Factor (ERF) defined for each participant and wherein the ERF is neither a tabular reduction nor an actuarial equivalent reduction;
iii. An ERF defined for each participant using factors comprising date of birth, date of hire, and compensation history with an employer;
iv. An accrued benefit defined by the fractional rule according to Internal Revenue Code Section 411(b)(1)(C);
v. Determination of a participant's benefit using more than 10 years of compensation;
vi. Expansion of the accrual boundary by use of a Social Security Supplement; and
vii. A pre-age 65 Normal Retirement Age in combination with a Social Security Supplement payable until Social Security Normal Retirement Age.

2. The defined benefit pension plan according to claim 1 comprising an applicable defined benefit plan, wherein the applicable defined benefit plan is defined according to Section 701 of the Pension Protection Act of 2006.

3. The defined benefit pension plan according to claim 1 comprising either a Cash Balance plan or a Defined Lump Sum plan.

4. The defined benefit pension plan according to claim 1 comprising at least five of the pension plan design components.

5. The defined benefit pension plan according to claim 1 comprising at least 6 of the pension plan design components.

6. The defined benefit pension plan according to claim 1 comprising seven of the pension plan design components.

7. The defined benefit pension plan according to claim 1 comprising pension plan design components iv and v.

8. A method for reducing exposure to civil liability based on provisions of the Employee Retirement Income Security Act (ERISA) and/or the Internal Revenue Code (IRC) relating to age discrimination, such exposure being associated with implementation and/or funding of a defined benefit pension plan, the method comprising: designing a defined benefit pension plan, wherein an accrued benefit satisfies accrual rules of IRC Section 411(b)(1) using the 133⅓% rule of subparagraph B, according to at least four of the following design elements:
i. Provide a football-shaped pattern of accrual boundary wherein a participant's normal retirement benefit must be at least as great as the greatest of the participant's early retirement benefits, and a single sum distribution from a defined benefit pension plan may not be less than the amount so specified;
ii. Define the form of an Early Retirement Factor (ERF) for each participant so that the ERF is neither a tabular reduction nor an actuarial equivalent reduction;
iii. Vary an ERF for each participant using factors comprising date of birth, date of hire, and compensation history with an employer.
iv. Apply the fractional rule according to Internal Revenue Code Section 411(b)(1)(C) to define an accrued benefit;
v. Determine a participant's benefit using more than 10 years of compensation;
vi. Use a Social Security Supplement to expand an accrual boundary; and
vii. Use a pre-age 65 Normal Retirement Age in combination with a Social Security Supplement payable until Social Security Normal Retirement Age.

9. The method according to claim 8, wherein the defined benefit pension plan is a Cash Balance Plan or a Defined Lump Sum Plan.

10. The method according to claim 8, wherein the defined benefit pension plan is designed according to at least 5 of the design elements.

11. The method according to claim 8, wherein the defined benefit pension plan is designed according to at least 6 of the design elements.

12. The method according to claim 8, wherein the defined benefit pension plan is designed according to design elements i-vii.

13. The method according to claim 8, wherein the defined benefit pension plan is designed according to design elements iv and v.

14. A method of providing increased flexibility with respect to an amount of a single sum distribution which may be paid according to a defined benefit pension plan, the method comprising the method according to claim 8, wherein the defined benefit pension plan is designed according to design element vi.

15. A method for stabilizing year to year costs associated with funding a defined benefit pension plan, the method comprising implementing the defined benefit pension plan according to claim 1.

16. The method for stabilizing year to year costs associated with funding a defined benefit pension plan according to claim 15, further comprising combining the defined benefit pension plan with a variable annuity plan.

17. The method for stabilizing year to year costs associated with funding a defined benefit pension plan according to claim 15, wherein the defined benefit pension plan is a Cash Balance Plan.

18. A computer system comprising: a central processing unit capable of implementing logic for generating a benefit according to the defined benefit pension plan as recited in claim 1, the processor being in communication with a unit housing the logic, wherein input to the processor comprises a participant's data and implementation of the logic generates an output.

19. The method according to claim 8, wherein the method comprises a computer implemented method.
